(19) United States
(12) Patent Application Publication
(10) Pub. No.: US 2005/0091146 A1
(43) Pub. Date: Apr. 28, 2005

(54) System and method for predicting stock prices

(76) Inventor: Robert Levinson, Santa Cruz, CA (US)

Correspondence Address: CARPENTER & KULAS, LLP, 1900 EMBARCADERO ROAD, SUITE 109, PALO ALTO, CA, 94303, US

(21) Appl. No.: 10/970,892

(22) Filed: Oct. 21, 2004

Related U.S. Application Data
(60) Provisional application No. 60/513,938, filed on Oct. 23, 2003.

(51) Int. Cl. G06F 17/60

(52) U.S. Cl. 705/37

(57) ABSTRACT

An apparatus and method for a stock investment method with intelligent agents is described and illustrated. In one embodiment, the invention is a stock prediction system that through experience learns to make money based on short-term stock predictions and due to inherent flexibility continues to be profitable in virtually all market environments.

### CLAIM OF PRIORITY

This patent application claims the priority and benefit of provisional patent application having Application No. 60/513,938 and filed Oct. 23, 2003, and fully incorporated herein by reference thereto as if repeated verbatim immediately hereinafter. Benefit of the filing date of Oct. 23, 2003 is claimed with respect to all common subject matter.

### FIELD

Embodiments of the present invention relate to the field of predicting and prediction. More particularly, embodiments of the present invention relate to prediction using computer programs.

### BACKGROUND

Various analytical and predictive techniques have been devised for purposes of predicting.

Some techniques may operate on simple concepts but may use variables or parameters that must be characterized or selected by a human user or operator in order to arrive at an analysis or prediction. For example, the common measure of a “moving average” of a stock's price is a simple calculation but the start and end of the time period used to calculate the moving average may vary.

Although traditional techniques have proven to be useful for prediction and analysis of stock prices, as the number and complexity of techniques grows it is often difficult for a human user of the techniques to effectively use the techniques and to combine or correlate the various results provided by the techniques.

### SUMMARY OF EMBODIMENTS OF THE INVENTION

Embodiments of the present invention are described in conjunction with systems, clients, servers, methods, and machine-readable media of varying scope. In addition to the aspects of the present invention described in this summary, further aspects of the invention will become apparent by reference to the drawings and by reading the detailed description that follows.

An apparatus and method for a stock investment method with intelligent agents is described and illustrated. In one embodiment, the invention is a stock predicting system that through experience learns to make money based on short-term stock predictions and due to inherent flexibility continues to be profitable in virtually all market environments.

### BRIEF DESCRIPTION OF THE DRAWINGS

FIG. 1 illustrates relationships between an embodiment of an application and various other modules, data stores, and interfaces, such as may be embodied in a medium or in media.

FIG. 2 illustrates an embodiment of an application utilizing intelligent agents.

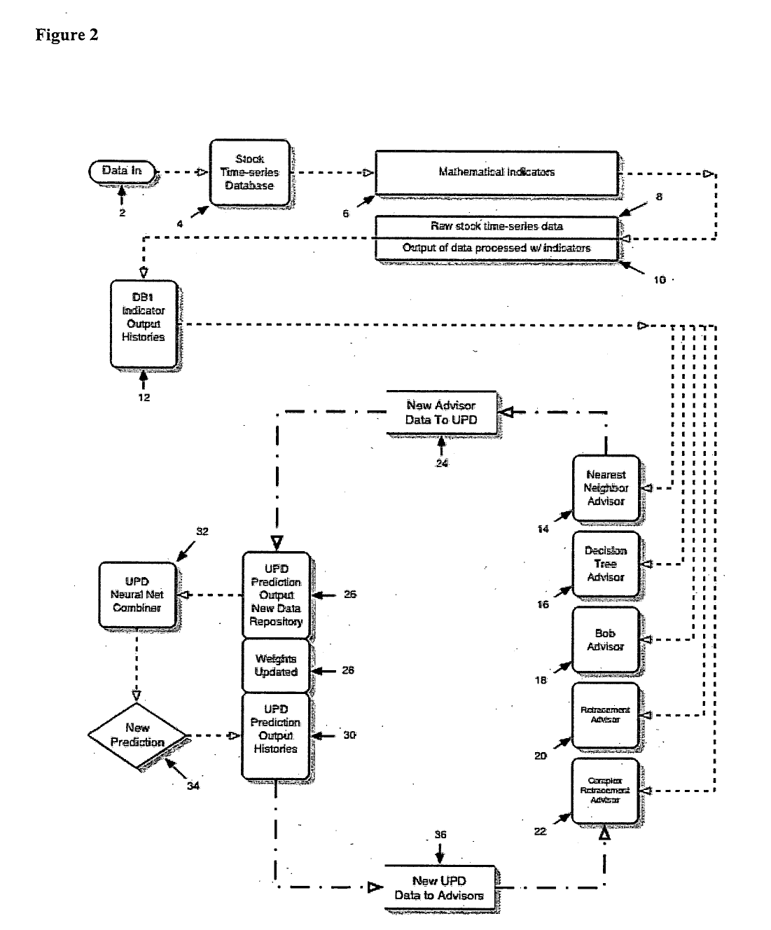

### DETAILED DESCRIPTION OF EMBODIMENTS OF THE INVENTION

Embodiments of the present invention are described in conjunction with systems, clients, servers, methods, and machine-readable media of varying scope. In addition to the aspects of the present invention described in this summary, further aspects of the invention will become apparent by reference to the drawings and by reading the detailed description that follows.

An apparatus and method for a stock investment method with intelligent agents is described and illustrated. In one embodiment, the invention is a stock predicting system that through experience learns to make money based on short-term stock predictions and due to inherent flexibility continues to be profitable in virtually all market environments.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

The reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment nor are separate alternative embodiments mutually exclusive of other embodiments.

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The flowing detailed description is, therefore, not to be taken in a limiting sense, and the scope of the present invention is defined only by the appended claims.

In one embodiment, the system is the implementation of a Technical Analysis approach to the stock market that is based on and exploits the following assumptions. Some of these assumptions are rather non-traditional and may even turn out to be false, but due to the flexibility of our overall architecture and interactions even bad choices can turn out to be good.

Stock prices are not a “random-walk” and past price-volume trading behavior provides enough information (if processed carefully) for future price behavior to be predicted at a level of statistical and profitable significance.

Given proper normalization and canonization of past data, all securities in all time frames exhibit behavior that is useful in helping to predict a future price move at a given time. For example, IBM's trading day tomorrow may resemble the MEX (Mexican) index 255 days ago, especially if a strong analogy can be established between their current and underlying technical environments. Despite these similarities, after normalization, each security or index may also exhibit characteristics and rhythms that are essentially their own “signature.”

A market predicting system must be complex enough to model a large gamut of technical trading strategies at varying time frames in order to simulate the habits of populations of traders that follow (or appear to) follow these strategies. Given a security, certain predicting strategies will have proved to be more useful than others at predicting recent stock behavior. A stock predicting strategy can never be “very bad” since its very badness can be exploited by trading contrary to it. The only useless features and predictions are those that are essentially random. However, perversely, some “mal-features” may manage to change their success as soon as one tries to exploit them. Clearly, it is these mal-features that must be ignored or avoided or exploited when properly recognized.

Combining these assumptions, a useful stock prediction can be developed as a function of:
a. The past price behavior of the stock,
b. Its past price behaviors, and the relationship to other securities in similar scenarios,
c. The relative successes of various features (trading strategies) at predicting correctly or incorrectly recent price behavior (weighing these successes or failures by the amount of win or loss as described in detail later). These features may come from traditional technical analysis books, general and chaos theory time-series analysis, and other human or computer designed features and “expertise modules”. As long as mal-features and over fitting can be avoided, adding new features to the system should improve performance in the long run once the system becomes adept at using these features,
d. The rhythm of the successes and failures of individual features. Features themselves may be viewed as securities for which predictions (at a meta-level) become relevant,
e. The Metropolis simulated annealing strategy of “heating up” (to encourage innovation) a system that is doing poorly and “cooling” a system that doing well is also used. Specifically, the system adjusts the learning rate to be higher (hotter) or lower (cooler) by decreasing or increasing the historical time period covered by output signals used by the system to make a final prediction. In one embodiment these adjustments are made in the final combining neural network so if the system is doing well it effectively considers larger advisor histories than it does when it is doing poorly. This added randomness should keep systems out of ruts created by any mal-feature behavior.

In one embodiment, the system is 5000+ lines of Lisp coupled with a large historical database. It takes about 5-minutes on a Sun SPARC II to predict tomorrow's stock price for a given security.

In one embodiment, the current securities and indices followed include: VOXX INSP TLAB MERQ CNXT NVDA AMCC VTSS CMVT NTPA MU ALTR PMCS ADI JNPR QLGC OSX DCLK ADCT WIND BKS ADBE EFII SEBL EMC SLR TJZ BBY SPLS SUNW WCOM QCOM APC LXK ALA CSCO GOX BBH MDT SGP VOD AMGN SWY HMA XOI MSFT AOL BGEN WLP BSYS CTL ONT TXCC REMD DIGL NTAP AMZN BVSN XLNX RNWK DELL PWER JDSU IDTI ATML NANO TLGD YHOO MOT COF ORCL IDPH BRCM NOK TXN XAU CHBS WMT XLE QQQ PAYX GE IBM TYC IXIC MEX OEX PFE DJI Indices followed include: OEX, COMPX, XOI, XAU, OSX AND MEX.

In one embodiment, the system employs the following major advisors. The addition of each advisor contributed successfully to the system, so adding more in the future may be of additional benefit. Moreover, each advisor has an “anti” version which always bets contrary to it. For a given stock at a given time these advisors are deemed more or less relevant to future predictions. Details of rhythmic timing and advisor weighting mechanisms are not presently described, and these algorithms may affect success.

Nearest Neighbor Advisor: Finds the historical precedent which best matches the current situation and reasons by analogy with the situation to make the prediction.

Decision Tree Advisor: Develops a decision tree which explains 90 percent of past price movement as a function of the indicators listed below. Thus, the decision tree represents a “pattern that predicts the past.” Given a security, the Decision Tree advisor uses the current decision tree to make its prediction for that security.

Bob Advisor: a method of combining the indicators used in the system based on human intuition.

Retracement Advisor: a day trading system based upon the system published by Joe DiNapoli in the book “Trading with Dinapoli levels.”

Complex Retracement Advisor: a system that combines a neural net with traditional Fibonacci retracement anaylsis

For each security the system updates and stores the following features on a daily basis.

“Name of security:”

| | |
|---|---|
| “Positive NN weight”: | Current weight of Nearest Neighbor |
| advisor. | |
| “Negative NN weight”: | Current weight of Anti Nearest Neighbor |
| advisor. | |
| “Positive DT weight”: | Current weight of Decision Tree Advisor. |
| “Negative DT weight”: | Current weight of anti-Decision Tree Advisor. |
| “Positive BOB weight: | Current weight of Bob advisor. |
| “Negative BOB weight”: | Current weight of Anti-Bob advisor. |
| “Positive JOE weight”: | Current weight of Joe advisor. |
| “Negative JOE weight”: | Current weight of Anti-Joe advisor. |

“Positive FIBO weight”: Current weight of Fibonacci advisor
“Negative Fibo weight”: Current weight of Anti-Fibonacci advisor.
“Alpha”: A timing parameter

| | |
|---|---|
| “Positive Trendpred Weight”: | Weight of midterm trend continuing. |
| “Negative Trendpred Weight”: | Weight of midterm trend discontinuing. |
| “Positive Shortpred Weight”: | Weight of short term trend continuing. |
| “Negative Shortpred Weight”: | Weight of short term trend |
| discontinuing. | |

“Beta”: A timing parameter
“Facilitation in Up trends”: Ease of movement in up trends.
“Facilitation in Down trends”: Ease of movement in down trends.
“Average Up Retracement”: Average percent retracement after an uptrend.
“Average Down Retracement”: Average percent retracement after
a downtrend
“Beginning of current trend”: how many days since current trend began.
“Total change in previous trend”: how much has trend covered.
“RSI 8”: 8 period stochastic
“3 fast rsi”: 3 period fast stochastic
“3 slo rsi”: 3 period slo stochastic.
“mavg8 ”: 8 day average
“mavg17 ” 17 day average
“mavgdiff9”: 9 day moving average of 17-8.
“Previous stochastic reading ”.
“Previous MACD reading:”

| | |
|---|---|
| “Average advance 15 ema” | average advance in last 15 days. |
| “Average decline 15 ema” | average decline in last 15 days. |
| “Projected Drummond High” | Drummond Geometry trend projection. |
| “Projected Drummond Low” | ″ ″ ″ ″ |

“Price Pulse High”: Price pulse trend projection
“Price Pulse Low”: Price pulse trend projection
“Fuel”: measure of stock power
“Positive Reactivity”: how performs after up day
“Negative Reactivity”: how performs after down day
“3 day Pivot:” trading pivot 3 day avg.
“Pivot sum:” how far from pivot
“Pivot trend average: How far do we usually go on average.
“5 day avg. facilitation:”
“34 day avg. facilitation:”
“5 day avg. force”
“34 day avg force”
“34 day avg force”
“winning/losing streak:” # of wining or losing days in a row.
“range streak:” # days of increased range
“facilitation streak:” # of days of increased ease
“trend avg. prediction:” average trend length
“real prediction:” our prediction
“last nearest neighbor prediction”
“last decision tree prediction”
“last bob-based prediction”
“last joe-based prediction”
“last fred-based prediction”
“last composite prediction:” previous prediction
“13 day moving average:”
“public power:” how stock performs during night time
“pro power:” how stock performs during day time
“bear power:” downward tendency
“bull power:” upward tendency
“trend up/down:” direction of current short term trend
“key high:” last important high
“key low:” last important low
“current trend length:” # of days
“current avg. trend length:” # of days that is usual.
“trendrangetotal”; how much range in current trend.
“avg. pivas support” measure of support levels
“prev pivas support” measure of support levels.
“current pivas support”
“ 3 day avg. range”
“ 34 day moving average”
“ 5 day moving average”
“ 34 day diff from avg”
“5 day diff from average”
“ obos avg” on balance stochastic
“ 10day range average”
“ facilitation”
“ adaptive fair price:”
“ adaptive momentum: ”
“Fibonacci support levels:”
“Fibonacci resistance levels:”
“ previous closes(most recent to least):”
“previous open:”
“previous high:”
“previous low:”
“previous close:”
“ open:”
“ high:”
“ low:”
“ close:”
“ lohi:”
“ change:”

Indicators: The following “low-level” indicators are used by the advisors in making daily predictions. They are composites of the features described above:

```
“dayofweek” we have discovered that the day of the week
is an important trading feature!!
  “breakdirection OEX” stocks are compared to the performance
  of the OEX
  “Joe signal OEX”
  “Uptrend facilitation OEX”
  “Downtrend facilitation OEX”
  “Uptrend retracement ratio”
  “Downtrend retracement ratio”
  “advance/decline ratio OEX”
  “within Drummond Range OEX”
  “within PricePulse Range OEX”
  “fuel OEX”
  “Positive Reactivity OEX”
  “Negative Reactivity OEX”
  “versus pivotpoint OEX”
  “ Pivot trend clock OEX”
  “ Pivot trend clock - XAU” comparison with to gold index
  “ Pivot trendclock - XOI” comparison with oil index
  “5dayfacilitation versus 34 day facilitation OEX”
  “5day force versus 34 day force OEX”
  “winning streak OEX”
“range increase streak OEX”
“facilitation increase streak OEX”
“average of trend length predictions OEX”
“aboveorbelow13dayavg OEX”
“public OEX”
“professionals OEX”
“bull ratio OEX”
“uporddown trend OEX”
“currenttrendversus avg OEX”
“vs averagepivas OEX”
“ vs prepivas OEX”
“withincurrentkeyrange OEX”
“relative rangesize OEX”
“5versus34momentum OEX”
“obos OEX”
“fairprice OEX”
“lohi OEX”
“breakdirection”
“Joe signal”
“Uptrend facilitation”
“Downtrend facilitation”
“Uptrend retracement”
“Downtrend retracement”
“ax/axdx ratio”
“within Drummond Range”
“within PricePulse Range”
“fuel”
“Positive Reactivity”
“Negative Reactivity”
“versus pivotpoint”
“ Pivot trend clock”
“ 13 day relative strength in ranges vs. oex”
“ 5dayfacilitation versus 34 day facilitation”
“ 5day force versus 34 day force”
```

### Modeling Process

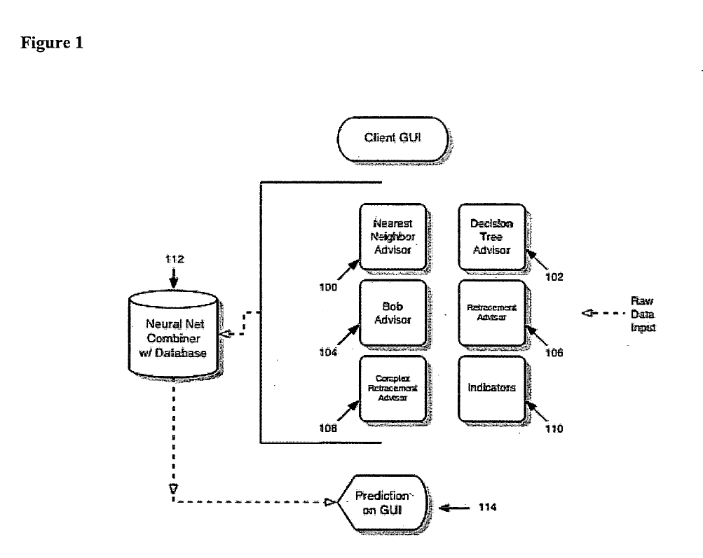

FIG. 1 illustrates the primary components of the system in summary form. At 100, 102, 104, 106, and 108, the system's 5 advisors are shown, which are comprised of both machine learning components, common trading models in the field that are enhanced with embedded machine learning components, and non-leaming proprietary (to the applicant) and common trading models. At 110, a group of proprietary and common indicators and compound indicators are shown. All of these components, described in more detail later, produce outputs which are then combined by a neural net combiner as shown at 112, producing a final prediction as shown at 114.

In a preferred embodiment as illustrated by FIG. 1, raw time-series stock data is entered into the process at 2, where all raw data is stored in a database as shown at 4. At 6, the first process step uses mathematical indicators to pre-process the raw time-series data. Each of the stocks for which the system is producing a prediction has a minimum indicator value which is equal to the change over the prior closing price for each respective stock. Additionally, each stock has its own value for each indicator it is pre-processed with.

At 8 and 10, the raw time-series data values and the indicator output values are shown as being entered into the Data Base 1, at 12. Data Base 1 stores all raw time-series data and indicator output histories for further use in subsequent processes by more complex components called Advisors, as described in more detail later.

Advisors comprise static or non-static mathematically based routines with embedded logic, which are generally more complex than the mathematical indicators used in the pre-processing of the raw time series database. In the context of embodiments of the present invention, static advisors do not have any learning function that causes changes in how the outputs are derived (i.e., they have fixed parameters), where non-static advisors have a degree of freedom generally governed by a learning mechanism and parameter ranges (e.g., as in a neural network). Different Advisors and combinations of advisors can have profound impact on the accuracy of predictions. Embodiments of the present invention employs specific implementations of machine learning components with unique proprietary enhancements described in more detail later.

As shown at 14, the Nearest Neighbor Advisor comprises a component that creates a vector of the input values, and using table lookup finds the vector of values in previous periods of time that is most similar (based on a selected distance metric) and “assumes” what happened then will happen again; thus, its prediction can be said to be reasoned by analogy with past data or “case based” reasoning. Usually the more periods the nearest neighbor has to consider the more reliable it will be. Embodiments of the present invention uses normalized indicator values (e.g., using percentage moves rather than raw values, and standard deviations to normalize the size of moves) to allow case data on different stocks to be relevant candidates for the current query. For example, what IBM did on May 22, 1998 may be viewed as a relevant case for predicting the MEX (Mexican Stock Index) on Jun. 11, 2004, if their normalized indicator value vectors are similar

As shown at 16, a Decision Tree Advisor, is informally a conditional series of “tests” that are applied to the input, where depending on the outcome of the tests (a path through the tree), a prediction is made. Given n samples of prior instances of the classification path of the data as seen in the input history, the system uses a traditional “minimum entropy” heuristic that attempts to approximate the smallest “explanation” of the data over that period. For example, a small decision tree may, by way of example only, look like the following:

```
If 13mvag is > close
    if 23ema is < high
        then expect 2.2% gain next period (5 samples)
            else expect 0.1% loss next period (2 samples)
          else
        if up 3 days in a row expect 4.5% drop next period (1 sample)
    else expect 0.5% gain (7 samples).
```

Embodiments of the present invention comprises the use of decision trees in a manner to identify and then possibly “mimic” or “fade” what it expects other trading systems may have discovered about the current period. To mimic means take prediction as is explained by decision tree as a final output, and to fade means to multiply its prediction by negative 1.

Additionally, which tests are asked of the data depends on the outcome of their parent tests, thus producing a tree structure. Unlike conventional use of decision trees used in the art, which utilize just one back-tested static tree forward in time, embodiments of the present invention continually creates new decision trees for each new period (e.g., each day). Further, the decision trees operate on normalized data, such as like the data produced from the implementation of nearest neighbor, in order to allow rules to be learned across differing types of data, e.g., individual stocks and stock indices.

As shown at 18, the Bob Advisor combines all of the indicator outputs to create an intermediate prediction for each respective stock. The Bob Advisor is an example of a static advisor because is not adaptive, treating every stock the same given a historical record of indicator values. Note it takes each stock's data and computes a “score” which is based on the applicant's personal heuristics. The score is initialized to 0 and then adjusted for each rule. For example, if the 5 Day Average Facilitation is greater than the 34 Day Average Facilitation the score is increased by 1. If the 18 Day Average is greater than the 40 Day Average the score is increased by 5.0 else decreased by 5.0 etc. Finally, the total score is normalized into a range of −3.0% and 3.0% which represents expected change in each respective stock's price as of the next day's Close.

As shown at 20, an embodiment of the Retracement Advisor is based upon Joe DiNapoli's published trading methods which makes use of specific settings for MACD (moving average convergence divergence using several different moving averages each with different period parameters) stochastic indicators and delayed moving averages to generate a buy and sell signal of varying strength. The Retracement Advisor is designed to mimic the behavior of day traders who are following traditional stochastics and moving averages on their trading screen, thus exploiting any impact on stock price formation that results directly or indirectly from large populations of market participants using the same common trading signals. The unique implementation comprises the use of only a subset of the published method, excluding Fibonacci support and resistance levels. Rather, only the formulas (i.e., not chart patterns) are used, to produce a magnitude prediction rather than a trading signal, which is done by normalizing the trading signals the formulas produce and resealing the outputs to be within the range of typical market movements as measured by standard deviations.

As shown at 22, the Complex Retracement Advisor comprises a machine learning mechanism embedded into a traditional Fibonacci retracement analysis system. The Complex Retracement Advisor foregoes the assumptions of stock price retracements (i.e., rebounds) based on Fibonacci ratios (e.g., 0.382 and 0.500 and 0.618 ratios) of the most recent trends, and learns non-linear effect of a stock's price reaching a support level (the price a stock trades at or near, but does not go lower than, over a certain period of time, e.g., the floor) and resistance level (the price a stock trades at or near, but does not go higher than, over a certain period of time, e.g., the ceiling). That is, rather than assuming the traditional ratios hold true, it learns what actually happens. Resistance and support price levels are defined as prices at which short-term trends changed. The Complex Retracement Advisor is a non-linear neural network (specifically, a multi-layer gradient descent with 100 non-linear interior nodes representing products of proprietary variables). It learns a non-linear combination of the 3 most recently identified support levels and the 3 most recently identified resistance levels and attempts to predict the next daily change in a stock's Closing price.

At 14, 16, 18, 20, and 22, the Advisors that are shown further process the indicator output data stored in Data Base 1, producing output values that are representative of each Advisor's respective prediction for the next day's closing price. At 24, the outputs of all Advisors are entered into the second database called UPD, shown at 26. UPD Neural Net Combiner, shown at 34, is responsible for the next step in the prediction process. This Combiner is a neural net which reviews all of the new Advisor predictions for each stock's closing price, and then compares them to the actual closing prices stored in Data Base 1, updating the weights for each Advisor (each stock has negative and positive weights for each advisor), which weights are stored in a table in UPD as shown at 28. The weights represent what the Combiner has learned (i.e., its memory) about the accuracy of the Advisor predictions, where the final prediction for each respective stock is a learned linear combination of all advisor outputs for that stock. The Combiner comprises a traditional gradient descent neural network that attempts to learn a linear combination of its input weights to produce predictions that minimize their error. In the context of embodiments of the present invention, the Combiner creates an output which is a linear combination of all Advisor predictions for each respective stock.

Unlike most “weighted-expert” learning schemes, embodiments of the present invention are actually able and willing to assign negative weights to Advisors that are often wrong, thus, using their information as a contrarian would (i.e., learning how to exploit wrong predictions by doing the opposite). Other advances over the prior art include the fact that each instrument has its own neural net Combiner, which is itself evolving over time. In other words, the same exact predictions from the group of Advisors may not be interpreted the same way as an identical previous instance, even for the same stock. In general the system views Advisors as having cyclical tendencies not unlike stocks themselves, so that as an Advisor gets “hot” or “cold” or “bottoms” or “tops” this can be learned and exploited using a unique implementation of simulated annealing, which is incorporated into the mathematical underpinnings of the weighting mechanism in the neural net Combiner.

At 34, each new final prediction delivered to the user, with this new prediction being stored in UPD Prediction Output Histories table as shown at 30. This final prediction then forms a part of a historical record of final outputs and their accuracies that are also reviewed by the Combiner prior to each new prediction task, and given it's own weighting used in the Combiner process. At 36, the new predictions are fed back for use by particular advisors in the next iteration (this conceptual, in practice, the new predictions are simply stored in the appropriate database tables where they are accessed at during the next prediction task). For example, the Complex Retracement Advisor updates its multi-layer neural net weights using the new prediction values, and the Nearest Neighbor Advisor and Decision Tree advisors use prior predictions as part of the set of indicator values they review with the next prediction task.

### Further Description of An Embodiment

Thus practice of embodiments of the present invention performs one or more of the following features:
i) The use of a large pool of indicators for pre-processing raw data, including those that may not be relevant or that don't work well on their own rather than a small subset of definitely relevant indicators selected by an expert;
ii) The use of the change in a security's price over the prior period as a default minimum indicator output for use as an input to higher level advisors;
iii) The use of higher level signal generating components called advisors or agents that then further process the indicator pre-processed data producing a second order signals that are then combined by a neural network which iteratively learns to use the output signals to make more accurate predictions;
iv) The use of machine learning algorithms together with static algorithms to produce output signals that are inputs to a neural network;
v) The use of non-neural network machine learning algorithms to produce output signals that become inputs to a neural network;
vi) The use of nearest neighbor, decision tree and neural network algorithms together in a single automated system for predictive modeling;
vii) The embedding of neural networks into common analysis systems used in the field (such as Fibonacci) to learn the non-linear effects of price behavior meeting the conditions the original unimproved analysis system is intended to identify.
vii) The use of normalization of securities and market indices time-series data with disparate quotation bases for purposes of comparing price activity and drawing analogies.
ix) The use of historical time-series data for a group of securities, neural network learned weighting of the predictive accuracy of technical indicators used to pre-process time-series data, and the identification of behavioral analogies within the group by nearest neighbor and decision tree algorithms as a method for predicting future behavior of securities in the group.
x) The modeling and prediction of system features themselves (such as particular indicator outputs) that have been determined to be relevant for the current prediction task, and the use of these meta-level predicted outputs to giving deeper meaning to the features role in the current prediction task.
xi) The use of Metropolis simulated annealing to “heat up” (encourage innovation) the system when it is performing poorly and “cooling” the system when it is doing well through implementation within the neural network algorithm weighting mechanism that produces the systems final predictive output.
xii) No pre-biased conception of relationship of indicator to price data (e.g. traditional use of indicator may actually be opposite of the case). The ability to trade counter to the advice of an advisor, indicator, or system.
xiii) Use of machine learning advisors dynamically changing over relatively short time frames as opposed to trading one static, learned, backtested system.
xv) Ability to determine average trend length dynamically over time and use this to adjust indicators that require one to specify a period of time. (e.g. system may have a moving average bases on “3 trend lengths.”
xvi) Specific groups of traders following certain indicators or systems are identified (recognized by abnormal short term results of such indicators or systems). Advisors recent histories are observed and their outputs are normalized based on recent periods (e.g., 50) based on the number of standard deviations from the mean. So that an advisor that is consistently predicting a stock price will move “up 3%” or “up 2.5%” switches to “up 2%” the system will actually treat this as a negative signal since the number of deviations from the 50-period mean is now negative. An assumption is that trading populations are becoming less correlated with bullish signals from this advisor.
xvii) The ability to trade counter to the advice of an advisor, indicator, or system is a function of the learning mechanism and the allowance of negative weights plus the normalization procedure above.
xviii) A mutual fund and stock “scoring” system based on human assessment of the individual value of a large set of indicators is used as an advisor. The human assessment might be “intuitive” but wrong, however the system adjusts for this (as with any advisor or indicator) when producing the final prediction.
xix) The ability to determine average trend length dynamically over time and use this to adjust indicators that require one to specify a period of time. (e.g. system may have a moving average bases on “3 trend lengths”. The system keeps track of the number of periods between changes in short term trend indicator and then takes a 3-period EMA of these.xx) The use of Anti-Advisors in the neural network weighting mechanism, for example:with 4 advisors we have 10 weights:
   A1+ A1−
   A2+ A2−
   A3+ A3−
   A4+ A4−
   Bulls Bears

If, for example, A1 predicts up 2 percent and A3 predicts up 1.3 percent and A2 predicts down 1.5 percent and A4 predicts down 0.7 percent.

If the market actually goes up 1 percent:

Then A3 would be weighted 1/0.3 (actually an ema6 of these over time)
since its error is 0.3
A2 would be weighted 1/2.5
A1 would be weighted 1/1
A4 would be weighted 1/1.7

A1− would be viewed as having said down 2 percent (being the anti of A1) and hence would be weighted 1/3.0
A2− would be weighted 1/0.5
A3− would be weighted 1/2.3
A4− would be weighted 1/0.5

Note that A3+ and A4− get the strongest weights: A3 was accurate and the opposite of A2 was also accurate.

Bulls would get any positive movement not explained by the advisors and their weights, and bears would get any negative movement not explained by the advisors and their weights.

If, for example, the consensus prediction was 0.8 percent, then bears would get 0.2 (1-0.8) and bears 0.0.

This is just one way of doing this (assigning reward and punishment)—there are

The primary improvement over prior art is the conception of the A1− A2− A3− and A4− anti-advisors.

The actual code weights are here:

(w1 (initial-range-10) :type float) ; “positive NN weight”
(w2 (initial-range-10) :type float) ; “negative NN weight”
(w3 (initial-range-10) :type float) ; “positive DT weight”
(w4 (initial-range-10) :type float) ; “negative DT weight”
(w5 (initial-range-10) :type float) ; “positive BOB weight”
(w6 (initial-range-10) :type float) ; “negative BOB weight”
(w7 (initial-range-10) :type float) ; “positive JOE weight”
(w8 (initial-range-10) :type float) ; “negative JOE weight”
(w9 (initial-range-10) :type float) ; “positive FIBO weight”
(w10 (initial-range-10) :type float) ; “negative Fibo weight”

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROM's, and magnetic-optical disks, read-only memories (ROM's), random access memories (RAMs), EPROMs, EEPROMs magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

From the foregoing, it will be appreciated that specific embodiments of the invention have been described herein for purposes of illustration, but that various modifications may be made without deviating from the spirit and scope of the invention. In some instances, reference has been made to characteristics likely to be present in various or some embodiments, but these characteristics are also not necessarily limiting on the spirit and scope of the invention. In the illustrations and description, structures have been provided which may be formed or assembled in other ways within the spirit and scope of the invention.

In particular, the separate modules of the various block diagrams represent functional modules of methods or apparatuses and are not necessarily indicative of physical or logical separations or of an order of operation inherent in the spirit and scope of the present invention. Similarly, method have been illustrated and described as linear processes, but such methods may have operations reordered or implemented in parallel within the spirit and scope of the invention.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. A method for predicting a stock price comprising:
1.1. Pre-processing stock data from a large set of mathematical indicators to produce indicator output signals;
1.2. Entering the indicator output signals into a database;
1.3. Processing with advisors the indicator output signals to produce advisor output signals;
1.4. Enter the advisor output signals into a database; and
1.5. Inputting the advisor output signals into a neural network to produce a prediction of a stock price;
1.6. Entering the neural network prediction into the database; and
1.7. Iteratively updating the neural network weights for all stocks and system components upon receipt of new data.

2. The method of claim 1, wherein the indicators can be any form of signal generating algorithm or output device.

3. The method of claim 1, wherein the minimum default indicator is the calculated change of a data value over the prior data value in the series.

4. The method of claim 1, wherein machine learning based advisors process the indicator output signals.

5. The method of claim 4, wherein the machine learning algorithms are nearest neighbor and decision tree algorithms.

6. The method of claim 5, wherein the nearest neighbor and decision tree algorithms operate in parallel with other advisors, the method further comprising: static mathematical advisors and hybrid mathematical advisors with embedded learning mechanisms.

7. The method of claim 6, wherein the learning mechanism embedded in the otherwise static advisor is a neural network.

8. The method of claim 1, wherein nearest neighbor, decision tree and neural network algorithms are used together in a single system.

9. The method of claim 1, wherein the raw data is normalized so that disparate data types can be used for reasoning by analogy.

10. The method of claim 1, wherein indicator output signals and features which are functions of indicator output signals, are themselves predicted by the system and correlated with stock price predictions.

11. The method of claim 1, wherein simulated annealing is implemented within the neural network.

12. The method of claim 11, wherein simulated annealing is a process comprising: a mechanism for adjusting the learning rate to be higher (hotter) or lower (cooler) by increasing or decreasing, respectively, the historical time period covered by output signals used by the system to make predictions.

13. The method of claim 12, wherein the simulated annealing process is implemented in the neural network combiner and operates on advisor output signals.

14. The method of claim 5, where the use of the machine learning algorithm based advisors' signal outputs are dynamically changing as opposed to being locked based upon a backtested system.

15. The method of claim 1, wherein the indicators are not related to particular instruments or specified for a particular purpose, allowing their output signals to be used in any way by the system, including contrary to their traditional use.

16. The method of claim 1, wherein an apparatus determines the average trend length dynamically, comprising:

17. The method of claim 6, wherein the advisors comprise: a mutual find and stock scoring system based upon the human assessment of the individual value of a large set of indicators; a trading system based upon Joe DiNapoli's published retracement system; and a trading system based upon traditional Fibonacci ratios with an embedded neural network.

18. A method of claim 1, wherein the advisor output histories are normalized based upon a set of recent periods, based upon the number of standard deviations from the mean, so that when the number of standard deviations from the mean is negative, the advisor output, although positive is treated as a negative output by the system.

19. A method of claim 18, wherein any output signal prediction including the neural net's final prediction can be output in a contrarian way.

20. A method for predicting a stock price comprising:
19.1. processing stock data from a set of mathematical indicators to produce indicator output signals;
19.2. entering the indicator output signals into a database;
19.3. processing with advisors the indicator output signals to produce advisor output signals;
19.4. entering the advisor output signals into a database; and
19.5. entering the advisor output signals into a neural network to produce a prediction of a stock price.

21. The method of claim 20 additionally comprising
entering the neural network prediction into the database; and
iteratively updating neural network weights for all stocks and system components upon receipt of data.

22. The method of claim 20, wherein the indicators comprise any form of signal generating algorithm or output device.

23. The method of claim 20, wherein the minimum default indicator comprises the calculated change of a data value over the prior data value in the series.

24. The method of claim 20, wherein machine learning based advisors process the indicator output signals.

25. The method of claim 24, wherein the machine learning algorithms comprise nearest neighbor and decision tree algorithms.

26. The method of claim 25 wherein the nearest neighbor and decision tree algorithms operate in parallel with other advisors,.

27. The method of claim 25 additionally comprising: static mathematical advisors and hybrid mathematical advisors with embedded learning mechanisms; the learning mechanism embedded in the otherwise static advisor is a neural network; the nearest neighbor, decision tree and neural network algorithms are used together in a single system; the raw data is normalized so that disparate data types can be used for reasoning by analogy; the indicator output signals and features which are functions of indicator output signals, are themselves predicted by the system and correlated with stock price predictions; and the simulated annealing is implemented within the neural network.

28. The method of claim 27 wherein simulated annealing is a process comprising: a mechanism for adjusting the learning rate to be higher (hotter) or lower (cooler) by increasing or decreasing, respectively, the historical time period covered by output signals used by the system to make predictions.

29. The method of claim 28, wherein the simulated annealing process is implemented in the neural network combiner and operates on advisor output signals.

30. The method of claim 25, wherein the use of the machine learning algorithm based advisors' signal outputs are dynamically changing as opposed to being locked based upon a backtested system; the indicators are not related to particular instruments or specified for a particular purpose, allowing their output signals to be used in any way by the system, including contrary to their traditional use; and the advisors comprise a mutual fund and stock scoring system based upon the human assessment of the individual value of a large set of indicators; a trading system based upon a (Joe DiNapoli's published) retracement system; and a trading system based upon Fibonacci ratios with an embedded neural network.

31. The method of claim 20 wherein the advisor output histories are normalized based upon a set of recent periods, based upon the number of standard deviations from the mean, so that when the number of standard deviations from the mean is negative, the advisor output, although positive is treated as a negative output by the system; and any output signal prediction including the neural net's final prediction can be output in a contrarian way.

32. A machine-readable medium having stored thereon instructions for:
processing stock data from a set of mathematical indicators to produce indicator output signals;
entering the indicator output signals into a database;
processing with advisors the indicator output signals to produce advisor output signals;
entering the advisor output signals into a database; and
entering the advisor output signals into a neural network to produce a prediction of a stock price.

33. The machine-readable medium of claim 32 additionally comprising instructions for:
entering the neural network prediction into the database; and
iteratively updating neural network weights for all stocks and system components upon receipt of data.

34. An apparatus for predicting a stock price comprising:
means for processing stock data from a set of mathematical indicators to produce indicator output signals;
means for processing with advisors the indicator output signals to produce advisor output signals; and
means for producing a prediction of a stock price from entering the advisor output signals into a neural network.
